(19) United States
(12) Patent Application Publication
(10) Pub. No.: US 2011/0065063 A1
(43) Pub. Date: Mar. 17, 2011

(54) Dental prophylaxis handpiece

(75) Inventor: Robert T. Bock, Brewster, NY (US)

(73) Assignee: ROBERT T. BOCK CONSULTANCY LLC.

(21) Appl. No.: 12/584,768

(22) Filed: Sep. 11, 2009

(51) Int. Cl. A61C 3/06; A61C 3/03

(52) U.S. Cl. 433/118; 433/125

(57) ABSTRACT

An improved low cost dental hygiene handpiece with high reliability coupling mechanism for disposable prophy angles and doriot type dental tool heads. The disposable prophy angles and dental tool heads are designed with non circular input shaft endings, engaging a matching non circular power output driver of the handpiece. The invention prevents the application of any axial force on the drive train and the driving motor both during the installation of the prophy angle and during the operation of the device, thereby eliminating the need for any axial trust bearings in the handpiece.

### BACKGROUND

1. Field of Invention

This invention relates to dental prophylaxis handpieces. More particularly the invention is concerned with improving the ease and effectiveness of the coupling between the input shafts of the disposable prophylaxis angles and the output shafts of the handpiece drive unit.

2. Description of Prior Art

Teeth cleaning, or prophylaxis, has been performed by dentists for a very long time. Initially, it was done by the utilization of a polishing cup inserted in place of a dental burr (drill) in a conventional handpiece, and used in conjunction with mild abrasives. It was an effective way to clean and polish the teeth, but required sterilization of the equipment between each patient. The cost of sterilization and the large inventory of expensive handpieces necessary in the office cried out for improvement.

A major economic improvement was achieved by the development of the Disposable Prophy Angles, which replaced the front portion of the dental handpieces. These disposable devices significantly reduced the operating expenses for the dentist, by reducing sterilization expenses in the dental office, and the necessary inventory of handpieces. The new Disposable Prophy Angles are all constructed with the standard 3/32 inch diameter round input shaft, typically of plastic construction. U.S. Pat. No. 3,727,313 describes such a typical prophy angle. The round input shaft of the device is identified as item 9. These prophy angles are connected to the conventional dental handpieces by various coupling mechanisms, which were originally designed for the use of dental burrs, requiring very high driving torques. These coupling mechanisms are utilizing collets, chucks, and various ball bearing gripping devices. They are complex and expensive. Also, due to the complex nature of these devices, their maintenance cost are high and the life expectancy of these devices are limited.

To demonstrate, I refer to the prior art described in U.S. Pat. No. 3,631,597, which shows a typical construction of dental handpieces. Item 58 in FIG. 2 represents the shaft of a dental burr or the shaft of a prophy angle, which is rotated by this handpiece. FIG. 6 shows the collet who's function is to grip the shaft 58. The collet is complex and an expensive item by itself. The other components in the drive train are the bearings, springs, sleeves, fasteners and the chuck body. To impart the rotational force on shaft 58 of a burr or prophy angle, this art contains in excess of fifty parts between the driving motor and shaft 58 of the dental burr or prophy angle.

The art was enhanced in 1996 by Coss as shown in U.S. Pat. No. 5,498,159. In his patent Coss teaches a new type of ball bearing coupling mechanism, which can be utilized with disposable prophy angles employing a plastic power input shaft. As Coss describes in the Summary of the Invention in Col 1, Lines 51-56, “The end of the plastic shaft fits into the receiving space of the tubular drive shaft, forming an interference fit with the balls. As the shafts are coupled, the balls create axially extending grooves in the exterior of the plastic shaft so that with rotation of the drive shaft the balls rotate the plastic tool head shaft.”

Coss succeeded in U.S. Pat. No. 5,498,159 to significantly reduce the complexity of the drive train between the driving motor and the tool head shaft.

However, the manufacturing cost of this ball bearing coupling mechanism is still high, requiring a sleeve housing numerous rows of balls and a complex ball retaining system, which also needed to force the balls into the plastic shaft to form the driving grooves. The process of forming these grooves requires a significant axial pressure on the output shaft of the handpiece. This axial pressure must be neutralized by additional trust bearings to assure that no axial force is placed on the drive motor.

The common problem with all of the prior arts are still the complexity of the systems, and the associated high maintenance requirements. Additionally, the axial forces created by the new ball bearing type coupling system require expensive counter measures, such as trust bearings, to eliminate early motor failures of the handpieces.

What has occurred to date is that not-withstanding the teachings of the prior art, the ability to manufacture an effective and inexpensive dental prophylaxis handpiece has remained unsolved. Because of the high cost of the current handpieces, the prophylaxis process is still limited to the dental offices. To make the prophylaxis process available to consumers in their homes, the further simplification of the drive trains and the associated reduction of the cost of the handpiece is necessary.

### OBJECTS AND ADVANTAGES OF THE INVENTION

Responding to the above described unresolved needs, the objective of this invention is to provide a simple and inexpensive mechanism to couple the power input shafts of all types of dental tool heads (including disposable prophylaxis angles) to the power output shafts of the dental handpieces. A further objective of the invention is to prevent the creation of any axial forces during the coupling event of the tool heads to the handpiece, and during the operation of the handpiece assembly. Elimination of the axial forces will allow the elimination of trust bearings and facilitate the utilization of a simple electric motor or an oscillator to drive the tool heads and prophy angles.

### BRIEF DESCRIPTION OF THE DRAWINGS

In the accompanying drawings, in which certain modes of carrying out the present invention are shown for illustrative purposes:

FIG. 1 shows a longitudinal cross section of the invention consisting of the prophylaxis handpiece, a disposable prophylaxis angle, a driving motor, a battery, and the electronic controls.

FIG. 2 shows a partial cross section of the device, limited to the output driver member and the input drive shaft of the prophylaxis angle.

FIG. 3 shows a longitudinal cross section of the disposable prophylaxis angle and the handle of the handpiece in a lined up position before their assembly.

### DESCRIPTION OF THE PREFERRED EMBODIMENTS

Referring in detail to the drawings, the reference numerals herein refer to the like numbered parts in the drawings. In the following discussion, unless otherwise qualified, the term “dental handpiece” refers to both a general purpose handpiece and a prophylaxis handpiece. Any reference to “tool head”, unless otherwise qualified, refers to both a general purpose dental tool head and a prophylaxis tool head. The meaning of the prophylaxis tool head includes the various configurations of the prophylaxis angles or as commonly referred to as the Prophy Angles.

A Dental Prophylaxis Handpiece 1, in accordance with the simplest form of the present invention, is shown in FIG. 1. The handpiece 1 comprises housing 14 having a handle end 2 and a tool head end 3 of tubular construction typically constructed of a rigid plastic material such as Acrylonitrile Butadiene Styrene (ABS). The tool head end 3 is tapered having a smaller diameter at the tip and a larger diameter where it joins the handle end 2. The purpose of this tapered construction is to form a press fit between the disposable prophylaxis angle 4 (or a tool head), and the tool head end 3 of the handpiece 1 as the disposable prophylaxis angle 4 is pushed onto handpiece 1, securing disposable prophylaxis angle 4 in fixed position during the teeth polishing operation.

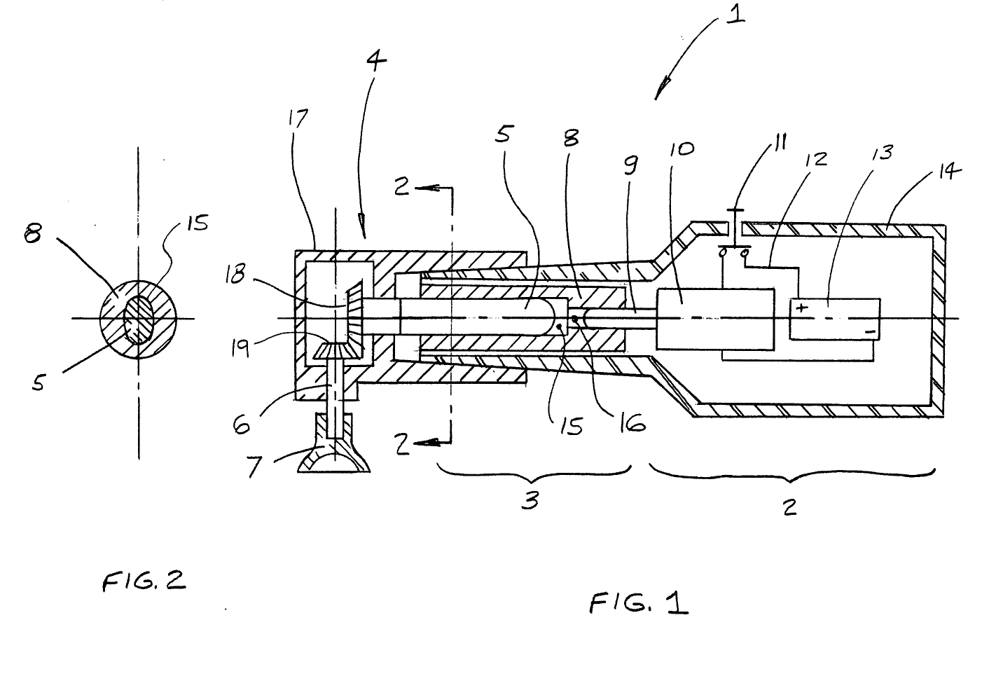

The handle end 2 houses the drive motor 10 powered by one or more battery 13 which connected to the motor 10 by connecting wiring 12 and a power switch 11. An output driver member 8 is firmly attached to the output shaft 9 of motor 10. The output driver member 8 is tubular in shape, having a round outside diameter to facilitate a vibration free rotation of the output driver member 8 within the tubular tool head end 3 and it is typically constructed of steel or brass. The inside cavity area 16 of the output driver member 8 is round to match the output shaft 9 of motor 10. The cavity area 15 of the output driver member 8 is oval shaped, as it is shown in FIG. 2.

The disposable prophylaxis angle 4 typically comprises a housing 17, an input drive shaft 5, and an output shaft 6 having a firmly attached polishing cup 7. Both the input drive shaft 5 and the output shaft 6 are mounted in a rotationally free mode within housing 17 and ending with a set of engaging bevel gears 18 and 19. The bevel gears 18 and 19 are held together by the prophylaxis angle housing 17. All components of the disposable prophylaxis angle 4 are typically constructed of an FDA approved plastic material, such as nylon.

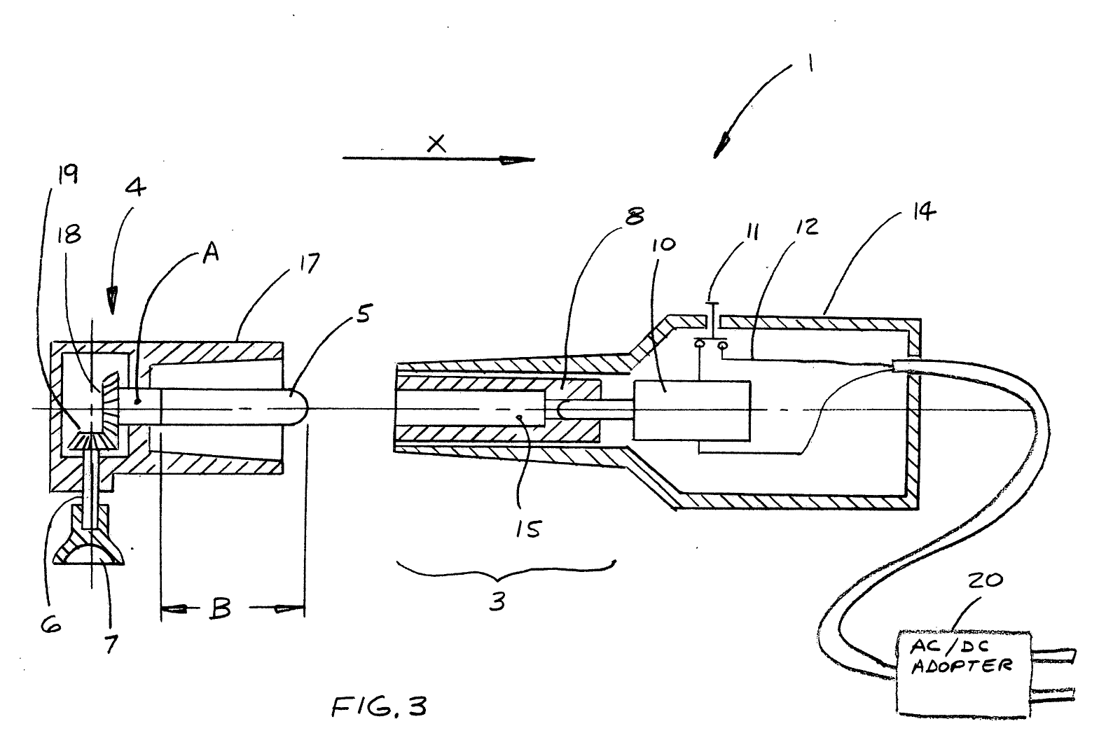

FIG. 3 shows the cross section of the disposable prophylaxis angle 4 and the cross section of the handle 14 of the Dental Prophylaxis Handpiece 1 in a lined up position before their assembly. As explained above in reference to FIG. 1 and shown in FIG. 2, the cavity 15 of the output driver member 8 is oval shaped. The input drive shaft 5 of the disposable prophylaxis angle 4 protrudes slightly from housing 17. The profile of the input drive shaft 5 in area A is circular to facilitate the vibration free rotation of input drive shaft 5 within prophylaxis angle housing 17. The profile of input drive shaft 5 in area B is oval shaped, matching the oval shaped cavity 15 of the output driver member 8 but having a slight clearance fit between them. See FIG. 2 showing oval profile of cavity 15 and area B of input drive shaft 5.

To assemble the disposable prophylaxis angle 4 onto the tool head end 3, the user lines up the protruding oval shaped end of input drive shaft 5 with the oval shaped cavity 15 of the output driver member 8 of the handle 14 of the device, gently inserts the tip of input drive shaft 5 into output driver member 8 and completing the assembly by pushing the disposable prophylaxis angle 4 onto the handle 14 in the direction indicated by arrow X. The completed assembly is shown in FIG. 1.

By activating power switch 11 the user energizes motor 10 which rotates the output driver member 8 and the inserted input drive shaft 5 transmitting rotational forces via engaged bevel gears 18 and 19 to output shaft 6 rotating the polishing cup 7.

The invention achieves its objectives of transmitting rotational forces from the output driver member 8 to the input drive shaft 5 by the utilization of matching non circular components, without any collets, chucks, ball bearing couplings, trust bearings, moving collars, and locking mechanisms. Due to the slight clearance fit between the input drive shaft 5 and the output driver member 8, no axial force is applied or transmitted to motor 10 and its bearings, neither during the coupling or during the operation of the system. The inherent reliability of the system is enhanced by the drastic reduction of the number of components within the drive train to a single output driver member 8 component. The invention succeeded to completely eliminate all axial forces on the drive mechanism and the motor, and to eliminate all wear points and deformations of the various shaft gripping mechanisms of the prior art. All of the known prior art devices require significant periodical maintenance and replacement of collets and chucks, while the output driver member 8 of this invention never needs maintenance or replacement.

In the past prophylaxis treatments were limited to the dental office due to the expensive dental handpieces. With the elimination of the expensive chucks, collets, and ball bearings the present invention can be constructed inexpensively and made available as a prophy maintenance tool for home use.

### SCOPE OF THE INVENTION

While the preceding description contain many specificities, these should not be construed as limitations on the scope of the invention, but rather as an exemplification of a preferred embodiment and additional embodiments. Many other variations are possible. Variously powered versions of the device can be constructed with replaceable batteries, rechargeable batteries, or the device can be powered by conventional power cords from the wall, or by an AC/DC adopter 20 as shown in FIG. 3.

The device may be constructed with a magnetic oscillator instead of the electric motor 10 shown in FIG. 1 and FIG. 3 to create 90 degrees of left and right circular oscillation in output driver member 8 whereby the polishing cup 7 may be oscillated instead of being rotated.

The device can be utilized in the dental office with a doriot type tool head as a dental handpiece using burrs and various other tools to perform drilling, polishing and other works dentists do to prepare teeth for fillings and various restorations in the dental office.

The male/female relationship between the input and output drive members can be reversed without impacting the utility of the device.

Disposable Prophy Angles are also available today with brush tips instead of prophy cups. Utilizing such a prophy angle, this device can also be utilized as an electric toothbrush.

Skilled artisans will readily be able to change dimensions, shapes and construction materials of the various components described in the embodiment. Accordingly, the scope of the invention should be determined not by the embodiment illustrated, but by the appended claims and their legal equivalents.

I claim:

1. A Dental Prophylaxis Handpiece, comprising:
a rigid elongated member having a tool head end and a handle end;
a prophylaxis tool head mounted on said tool head end having a non circular cross sectioned input drive shaft protruding from said prophylaxis tool head received by a matching non circular cross sectioned output driver member operative to transmit rotational or oscillation forces from said output driver member to said input drive shaft;
means attached to said output driver member operative for generating rotation or circular oscillation of said output driver member and said input drive shaft of said prophylaxis tool head and attached prophylaxis cup.

2. The handpiece of claim 1, wherein the prophylaxis tool head is a disposable device.

3. The handpiece of claim 2, wherein the prophylaxis tool head is secured on the tool head end of the handpiece by frictional means.

4. A Dental Handpiece, comprising:
a rigid elongated member having a tool head end and a handle end;
a dental tool head mounted on said tool head end having a non circular cross sectioned input drive shaft protruding from said dental tool head received by a matching non circular cross sectioned output driver member operative to transmit rotational or oscillation forces from said output driver member to said input drive shaft;
means attached to said output driver member operative for generating rotation of said output driver member and said input drive shaft of said dental tool head and attached tools.

5. A disposable prophylaxis angle, comprising:
a tubular housing of plastic material;
an input drive shaft mounted in rotationally free mode within said tubular housing, having non circular cross section ending for engaging a matching non circular power output drive member of a dental handpiece without creating any axial loading force on said power output drive member;
an output shaft mounted in rotationally free mode within said tubular housing in a substantially perpendicular position to said input drive shaft, supporting a flexible prophylaxis cup on external end of said output shaft, operative to engage and polish teeth in conjunction with the use of mild abrasives;
means to connect said input drive shaft and said output shaft within the said tubular housing operative for transmitting a rotational or oscillating motion from said input drive shaft to said output shaft and said flexible prophylaxis cup.
